(19) United States
(12) Patent Application Publication
(10) Pub. No.: US 2005/0167405 A1
(43) Pub. Date: Aug. 4, 2005

(54) Optical ablation using material composition analysis

(76) Inventors: Richard Stoltz, Plano, TX (US); Peter J. Delfyett, Oviedo, FL (US)

Correspondence Address: CARR & FERRELL LLP, 2200 GENG ROAD, PALO ALTO, CA, 94303, US

(21) Appl. No.: 10/916,366

(22) Filed: Aug. 11, 2004

Related U.S. Application Data
(60) Provisional application No. 60/494,102, filed on Aug. 11, 2003.
(60) Provisional application No. 60/494,275, filed on Aug. 11, 2003.
(60) Provisional application No. 60/494,274, filed on Aug. 11, 2003.
(60) Provisional application No. 60/503,578, filed on Sep. 17, 2003.
(60) Provisional application No. 60/512,807, filed on Oct. 20, 2003.

(51) Int. Cl. B23K 26/40

(52) U.S. Cl. 219/121.62; 219/121.69

(57) ABSTRACT

The present invention relates to methods and systems for controlling ablation based on analysis of material removed from a surface, that includes the steps of generating an initial wavelength-swept-with-time optical pulse, amplifying the initial pulse, compressing the amplified pulse to a duration of less than 10 picoseconds, applying the compressed optical pulse to the surface to cause material to be emitted from the surface, analyzing the material being emitted to at least partially determine composition of the removed material and using the analysis of material composition to adjust pulse energy and/or stop ablation.

### CROSS-REFERENCE TO RELATED APPLICATIONS

This application claims priority to U.S. Provisional Application: entitled “Material Composition Analysis Using Optical Ablation,” Ser. No. 60/512,807, filed Oct. 20, 2003 (Docket No. ABI-27); and U.S. Provisional Applications: entitled “Controlling Repetition Rate Of Fiber Amplifier,” Ser. No. 60/494,102 (Docket No. ABI-8); “Controlling Pulse Energy Of A Fiber Amplifier By Controlling Pump Diode Current,” Ser. No. 60/494,275 (Docket No. ABI-9); “Pulse Energy Adjustment For Changes In Ablation Spot Size,” Ser. No. 60/494,274, which were filed Aug. 11, 2003 (Docket No. ABI-10); and “Controlling Optically-Pumped Optical Pulse Amplifiers” Ser. No. 60/503,578, filed Sep. 17, 2003 (Docket No. ABI-23).

### TECHNICAL FIELD OF THE INVENTION

The present invention relates to material compositional analysis, and more particularly, to the analysis of compositions using short optical pulse vaporization.

### BACKGROUND OF THE INVENTION

Heretofore in this field, ablative removal of material is generally done with a short optical pulse that is stretched amplified and then compressed. A number of types of laser amplifiers have been used for the amplification.

Laser ablation is very efficiently done with a beam of very short pulses (generally a pulse-duration of three picoseconds or less). While some laser machining melts portions of the work-piece, this type of material removal is ablative, disassociating the surface molecules and ionizing their atoms. Techniques for generating these ultra-short pulses are described, e.g., in a book entitled “Femtosecond Laser Pulses” (C. Rulliere editor), published 1998, Springer-Verlag Berlin Heidelberg New York. Generally large systems, such as Ti:Sapphire, are used for generating ultra-short pulses (USP).

USP phenomenon was first observed in the 1970's, when it was discovered that mode-locking a broad-spectrum laser could produce ultra-short pulses. The minimum pulse duration attainable is limited by the bandwidth of the gain medium, which is inversely proportional to this minimal or Fourier-transform-limited pulse duration. Mode-locked pulses are typically very short and will spread (i.e., undergo temporal dispersion) as they traverse any medium. Subsequent pulse-compression techniques are often used to obtain USP's. Pulse dispersion can occur within the laser cavity so that compression techniques are sometimes added intra-cavity. When high-power pulses are desired, they are intentionally lengthened before amplification to avoid internal component optical damage. This is referred to as “Chirped Pulse Amplification” (CPA). The pulse is subsequently compressed to obtain a high peak power (pulse-energy amplification and pulse-duration compression).

### SUMMARY OF THE INVENTION

The method and system of the present invention uses an analysis of material vaporized by ultra-short pulse optical ablation (e.g., luminescence or atomic adsorption material composition analysis) in controlling the ablation of a target. Using ultra-short pulse optical ablation allows the removal of any type of material (including even diamond), and can do so with minimal-temperature rise, high-accuracy (as it avoids thermal effects during machining), and minimal-pressure by removing the top few microns of the exposed surface with atoms expelled at high velocity.

Material composition sensing can be done with high accuracy due to the avoiding of the normal ion-beam sputtering distortions, and the sensing used to adjust pulse energy or stop the ablation. Cutting, including hole-coring, can be controlled with material sensing of stop-indication layer or a difference in composition occurring on the surface of, or within the target. Pulse energy can also be adjusted for a difference in composition to more efficiently ablate. While a vacuum chamber could be used (as is generally required in Auger analysis), with this technique, a vacuum is not required. The atmosphere may also be air (preferably in some embodiments, but not necessarily, filtered) or an inert gas. One preferred system is with primary control by controlling repetition rate based on a set-point that is determined by material composition analysis (and may use stopping ablation based on material composition analysis as well).

This novel control technique uses short pulse optical ablation and composition analysis of exposed surfaces (including surfaces that were exposed by ablation of the material that was formerly above it, and thus can analyze at depth within the material, or even detect when the ablation beam has penetrated completely through the material). This type of material removal allows the removal of any type of material and can do so with minimal-temperature rise, high-accuracy (as it avoids thermal effects during machining), and minimal-pressure. Further, material composition sensing can be done with high accuracy due to the avoiding of the normal distortions due to sidewall evaporation, normal ion-beam sputtering distortions, etc. Material composition sensing can be used herein to adjust pulse energy or stop the ablation. For example optical ablation hole digging can be done to a precise depth using material sensing of one or more buried layers. In some embodiments, the system's primary control uses controlling repetition rate based on an adjustable set-point that is determined by material composition analysis (and/or stopping ablation based on material composition analysis).

The present method analyzes removed material from an exposed surface by generating an initial wavelength-swept-with-time optical pulse in an optical pulse generator; amplifying the initial pulse; compressing the amplified pulse to a duration of less than 10 picoseconds (preferably less than 1 picosecond); applying the compressed optical pulse to the surface, preferably with an energy of between 2 and 10 times optical ablation threshold) to cause material to be emitted from the surface; and using luminescence and/or atomic adsorption analysis of material being emitted to determine at least some of the composition of the removed material. The amplifying can be done with an optically-pumped-amplifier or a SOA (semiconductor optical amplifier).

As the top few microns of the surface are vaporized by ablation pulses, plumes of atoms leave at high velocity (e.g., as ions), and luminescence from the vaporized material can be detected and analyzed. Further, one or more light beams may be passed through the vaporized atoms for atomic absorption measurements, or material may be detected (e.g., on a crystal sensor) and analyzed.

Cutting, including hole-coring, can be controlled with material sensing of stop-indication layer or a difference in composition occurring on the surface of, or within the target. Pulse energy can also be adjusted for a difference in composition to more efficiently ablate. While a vacuum chamber may be used (as is generally required in Auger analysis), with this technique, a vacuum is not required. The atmosphere may also be air (preferably in some embodiments, but not necessarily, filtered) or an inert gas.

Ablation may also be done in a line to give ablation trench digging. In some embodiments, the composition of material being removed is sensed to determine when ablation reaches a stop-indication layer (which may be one or more buried layers, or some different type of material on the opposite side that indicates that cut is completely through the material). In some embodiments, during cutting the optical ablation spot is scanned by two piezoelectrically driven mirrors or one piezoelectrically driven mirror and a motor driven stage. The analysis of material composition may also be used to control the scanning, e.g., to change the length (and/or width) of the scan, or the rate at which the spot is scanned.

In some embodiments, more two or more optical amplifiers are used in a train mode to give a rapid and controllable material ablation rate, as the rapid and controllable rate provides a high density of vaporized material enabling even more accurate measurements of vaporized material. The compressed optical pulse may be applied to the surface in spot with an area between the areas of 1 and 50 micron diameter circles.

The present invention also includes a method of controlling ablation based on analysis of material removed from a surface by generating an initial wavelength-swept-with-time optical pulse; amplifying the initial pulse; compressing the amplified pulse to a duration of less than 10 picoseconds; applying the compressed optical pulse to the surface, to cause material to be emitted from the surface; analyzing the material being emitted to at least partially determine composition of the removed material; and using the analysis of material composition to adjust pulse energy and/or stop ablation.

The compositional determination may be using, e.g., luminescence, spectrophotomotery or atomic adsorption analysis of material being emitted to determine composition of the removed material. In some embodiments, the rate of material deposition on a sensor is used in the control. In another embodiment of the present invention the method of controlling an ablation system includes the steps of applying an optical pulse with a duration of less than 10 picoseconds to a surface, to cause material to be emitted from the surface; using analysis of material being emitted to determine at least some of the composition of the removed material; and using the composition determination in the control of the system.

The composition of material being sensed may be analyzed to determine when the ablation reaches a buried stop-indication layer. The optical ablation of material removal may be used during semiconductor fabrication, or cutting of a composite material, or during a medical procedure. The amplifier may be optically-pumped Cr:YAG amplifier.

The pulse repetition rate may be controlled based on a set-point that is determined by material composition analysis, and/or ablation may be stopped based on material composition analysis. The optically-pumping rate may also be controlled based on a set-point that is determined by material composition analysis, or the number of amplifiers used in a train mode may be changed based on the analysis.

Yet another method for controlling ablation based on analysis of material removed from a surface, includes, time compressing a wavelength-swept-with-time optical pulse; applying the compressed optical pulse to the surface, to cause material to be emitted from the surface; analyzing the material being emitted to at least partially determine composition of the removed material; and using the determination of material composition to control the ablation.

In one embodiment, the amplifying and compressing is done with an optically-pumped amplifier (e.g., Cr:YAG optically-pumped-amplifier) and an air-path-between-gratings compressor combination, and the amplified pulses are between 500 picoseconds and 3 nanoseconds in duration. The amplifier may be an optically-pumped, erbium-doped fiber amplifier, with power supplied by pump diodes. The amplifier may also be a SOA that directly powered by electricity. The air-path between gratings compressor may be, e.g., a Tracy grating compressor. In some embodiments, more than one amplifiers are used with one compressor. In some embodiments, the compressing is done with a chirped fiber compressor. Preferably, the system is controlled such that pulse energy density and ablation rate are independently controlled and in some embodiments, pulse energy density, optically-pumped amplifier operating temperature, and ablation rate are independently controlled.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The novel ablation techniques disclosed herein control ablation based at least in part on an analysis (e.g., luminescence, spectrophotometric and/or atomic adsorption) of material vaporized by short pulse optical ablation. The use of this type of material removal allows the removal of any type of material, and can do so with minimal-temperature rise, high-accuracy (as it avoids thermal effects during machining), and minimal-pressure. In some embodiments, the optical ablation spot is scanned by two piezoelectrically driven mirrors or one piezoelectrically driven mirror and a motor driven stage (that gives relative motion between the optical beam emitting probe and the wafer).

The optical ablation can be used in a wide range of processing (including semiconductor fabrication, medical applications, and composite material cutting. This can do Auger-type material composition sensing may be done with high compositional accuracy due to the avoiding of the normal Auger thermal distortions cone with ion-beam sputtering (for a Auger discussion, see “Practical Surface Analysis” edited by D. Briggs and M. P. Seah, Publisher: Chichester; New York: Wiley; Aarau: Salle+Sauerländer, c1990, 2nd ed). Optical ablation trench digging might be done to a precise depth using material sensing of stop-indication buried layer. Hard to dry-etch materials such as copper or noble metals can be patterned without using liquids (avoiding problems, such as capillary action, of melting or wet-etching). Ablative cutting removes a thin slice of material compared to that removed by sawing and there is never a need to replace blades. In ablative cutting, one or more beams can be introduced at perpendicular or non-perpendicular angles (using two or more beams at different angles can minimize cutting variations).

As the top few microns of the surface are vaporized, the atoms leave at high velocity (many leave as ions), and a light beam is passed through the vaporized atoms, and luminescence from the vaporized material is detected or atomic adsorption is measured. For a detailed discussion of luminescence and its relationship with other compositional analysis techniques, see C. R. Brundle, C. A. Evans, Jr., and S. Wilson, Encyclopedia of Materials Characterization, Butterworth-Heinemann, ISBN 0-7506-9168-9 (1992). See also atomic adsorption analysis by passing a light beam through the vaporized atoms in U.S. Pat. Nos. 6,075,588 and 5,936,716 to Pinsukanjana, et al.

Adjustment of pulse energy is described in the following co-pending applications that are hereby incorporated by reference herein: ABI-8 “Controlling Repetition Rate Of Fiber Amplifier” —Ser. No. 60/494,102; ABI-9 “Controlling Pulse Energy Of A Fiber Amplifier By Controlling Pump Diode Current” Ser. No. 60/494,275; ABI-10 “Pulse Energy Adjustment For Changes In Ablation Spot Size” Ser. No. 60/494,274; which were filed Aug. 11, 2003.

As ablation is most efficient at about three times the material's ablation threshold, and thus control of pulse energy density is very desirable. If the spot size is fixed or otherwise known, this can be achieved by controlling pulse energy; or if the pulse energy is known, by controlling spot size. A novel control of pulse energy was found that is much more convenient than changing the ablation spot size, that is control over amplified pulse energy. It was found that in fiber amplifiers, this can be done effectively by controlling repetition rate. Preferably, this is done by pulse selecting from an oscillator operating a higher repetition-rate, by selecting, e.g., every 5^{th}, 6^{th}, 7^{th}, 8^{th}, 9^{th}, or 10^{th} pulse gives step-wise adjustment of the fiber amplifier rep rate (⅕^{th}, ⅙^{th}, 1/7^{th}, ⅛^{th}, 1/9^{th}, 1/10^{th}, of the oscillator repetition rate) it is preferable that the oscillator rep rate be much higher than the fiber amplifier rep rate, to allow fine adjustment. An oscillator to fiber-amplifier rep rate ratio variable between 100 and 1,000 can give energy control in steps of less than 1%.

It was also found that the control of pulse energy is also more convenient than changing the ablation spot size, and in most embodiments, this is achieved by control of the pulse energy. With optical amplifiers it was found that control of pulse energy of an optical amplifier can be achieved by controlling pump diode current (e.g., by current through all the diodes, or turning some of them off). The pulse energy of semiconductor optical amplifiers can be adjusted by changing the current through the amplifier diodes as either the primary control of pulse energy, or as a fine-tuning to another type of pulse energy control. When multiple pump diodes are used, the control of pump current can be by turning off the current to one or more pump diodes.

It was found that in some amplifiers, pulse energy control be done effectively by controlling repetition rate. With amplifiers it was found that control of pulse energy of an amplifier can also be achieved by controlling pump diode current. The pulse energy may set for material being ablated, the optical pumping power fine-tuned by dynamic feedback from a spot-size sensor.

One preferred system is with primary control by controlling repetition rate based on a set-point that is determined by material composition analysis (and/or stopping ablation based on material composition analysis), and the pulse energy adjustment for changes in ablation spot size and/or for limiting component temperature by controlling pump diode current (with control of pump current being, e.g., by turning off the current to one or more of multiple pump diodes).

To conduct material composition analysis, ablation may be halted when a certain composition is detected or when a certain composition is no longer detected. Alternatively, material composition analysis may be used to adjust a pulse energy set-point for the material being ablated (e.g., to dynamically change the set-point from being about three (3) times the ablation threshold of a first material that was being ablated to being about three (3) times the ablation threshold of a second material that is being ablated). In some embodiments, both changes to pulse energy and halting ablation may be used.

Further, it is preferred that ablation rate be controllable independent of pulse energy. The use of more than one amplifiers in a mode where pulses from one amplifier being delayed to arrive one or more nanoseconds (or a few picoseconds) after those from any other amplifier, allows step-wise control of ablation rate independent of pulse energy.

The pulse energy controlled independently may generally use a beam of photons to energize the vaporized atoms, and then may use one or more sensors to measures photon emissions from the energized atoms. Frequency doubling may be used to get higher energy in the photons in the energizing photons. A narrowband filter may be used on the sensor to detect the presence of a particular type atom. A broadband tunable source may be used to generate the beam of energizing photons to more effectively couple energy into particular types of atoms. In some embodiments, grids or plates are used to separate vaporized into 2 or 3 streams (e.g., negative, positive, neutral) prior to being energized. As there is no masking current from ion-beam sputtering, currents from the vaporized streams (e.g., negative, positive, or both) can be a measure for additional information, including indication of penetration through an object (even without a luminescence measurement). Quartz crystal total mass measurements may also be made, including in separated streams. In some embodiments, time of flight measurements are made (e.g., counts ions with time) to aid in compositional analysis, and longer than normal flight paths may be used as the atom velocity is relatively high. Multiple passes of the energizing beam may be used to increase sensitivity. While vacuum chamber may be used in some types of measurements (as is generally required in Auger), with this technique, a vacuum is not required. The atmosphere can be air (preferably filtered) or an inert gas, especially in luminescence measurements.

High ablative pulse repetition rates are preferred (and give greater sensitivity) and the total pulses per second (the total system repetition rate) from the one or more parallel optical amplifiers is preferably greater than 0.6 million pulses per second. The use of a 1 nanosecond pulse with an optically-pumped pulse amplifier and air optical-compressor (e.g., a Treacy grating compressor) typically gives compression with ˜40% losses. At less than 1 nanosecond, the losses in a Treacy grating compressor are generally lower. If the other-than-compression losses are 10%, 2 nanoJoules are needed from the amplifier to get 1 nanoJoule on the target. Preferably, for safety purposes and for reducing reflective losses, 1550 nm light is preferably used. The use of greater than 1 nanosecond pulses in an air optical-compressor presents two problems; the difference in path length for the extremes of long and short wavelengths needs to be more three (3) centimeters and thus the compressor is large and expensive, and the losses increase with a greater degree of compression. Chirped fiber Bragg gratings can be used in place of the Treacy gratings for stretching and/or compressing.

Preferably, a semiconductor generated initial pulse is used, and one or more SOA preamplifiers may be used to amplify the initial pulse, especially before splitting to drive multiple amplifiers. Preferably a smaller ablation spot scanned to get a larger effective ablation area. The use parallel amplifiers generates a train of pulses and increases the ablation rate by further increasing the effective repetition rate (while avoiding thermal problems and allowing control of ablation rate by the use of a lesser number of operating amplifiers). Preferably, the system is operated with pulse energy densities on the surface of about three times the materials ablation threshold for greater ablation efficiency.

Ablative material removal often has an ablation threshold of less than one (1) Joule per square centimeter, but may occasionally require removal of material with an ablation threshold of up to about two (2) Joules per square centimeter. The use more than one amplifier in parallel train mode (pulses from one amplifier being delayed to arrive one or more nanoseconds after those from another amplifier. At lower desired powers, one or more amplifiers can be shut off (e.g., the optical pumping to a optically-pumped pulse amplifier), and there will be fewer pulses per train. Thus, with 20 amplifiers there would be a maximum of 20 pulses in a train, but most uses might use only three or four amplifiers and three or four pulses per train.

Generally, the optically-pumped amplifiers are optically-pumped CW, or quasi-CW (pumping and amplifying perhaps 500 times per second in one (1) millisecond bursts). In quasi-CW, there is a pause between bursts, and the ratio of durations of the pause and the burst may be adjusted for component temperature and/or average repetition rate control. Amplifiers may also be run in a staggered fashion, e.g., one on for a first half-second period and then turned off for a second half-second period, and another amplifier, dormant during the first-period, turned on during the second period, and so forth, to spread the heat load.

In such systems, input optical signal power can be controlled into the optical amplifier, optical pumping power of optically-pumped pulse amplifiers, timing of input pulses, length of input pulses, and timing between start of optical pumping and start of optical signals into the optical amplifier to control pulse power, and the average degree of energy storage in fiber. For example, with a 5 W Cr:YAG amplifiers operating at 20 kHz (and e.g., 250 microjoules), 10 optically-pumped pulse amplifiers could step between 20 kHz and 200 kHz. With 50% post-amplifier optical efficiency and 250 microjoules, to get 6 J/sq. cm on the target, the spot size would be about 50 microns. The amplified pulse might be 100 to 250 picoseconds long. A similar system with 30 optically-pumped pulse amplifiers could step between 20 kHz and 600 kHz.

In some embodiments, e.g., during cutting, the optical ablation spot is scanned by two piezoelectrically driven mirrors or one piezoelectrically driven mirror and a motor driven stage. The zone of ablation may be scanned with a relatively small spot to get a larger effective ablation area. The analysis of material composition may also be used to control the scanning, e.g., to change the length (and/or width) of the scan, or the rate at which the spot is scanned (see the incorporated by reference provisional ABI-6 “Scanned Small Spot Ablation With A High-Rep-Rate” Ser. No. 60/471,972, filed May 20, 2003).

It should be noted that optically-pumped optical pulse amplifiers (including, and those used to pump other optical devices) in general (including, and in such shapes as slabs, discs, and rods) can be controlled as in co-pending provisional applications, relevant portions incorporated herein by reference. Note further that lamp-pumped energy can be controlled by controlling the pumping lamps in a manner similar to that of controlling pump diode current. In some embodiments, active-diode diode pump-current is used to control the amplification of an active mirror. Generally optical pump device (diode or lamp) current is controlled either directly or indirectly by controlling voltage, power, and/or energy. As used herein, controlling current can include shutting off one or more optical pump devices, when multiple pump devices are used. Another alternate is to measure light leakage from the delivery fiber to get a feedback proportional to pulse power and/or energy for control purposes.

Information of such a system and other information on ablation systems are given in co-pending provisional applications listed in the following paragraphs (which are also at least partially co-owned by, or exclusively licensed to, the owners hereof) and are hereby incorporated by reference herein (provisional applications listed by docket number, title and provisional number):

Docket number ABI-1 Laser Machining provisional application Ser. No. 60/471,922; ABI-4 “Camera Containing Medical Tool” Ser. No. 60/472,071; ABI-6 “Scanned Small Spot Ablation With A High-Rep-Rate” Ser. No. 60/471,972; and ABI-7 “Stretched Optical Pulse Amplification and Compression”, Ser. No. 60/471,971, were filed May 20, 2003;

ABI-8 “Controlling Repetition Rate Of Fiber Amplifier” Ser. No. 60/494,102; ABI-9 “Controlling Pulse Energy Of A Fiber Amplifier By Controlling Pump Diode Current” Ser. No. 60/494,275; ABI-10 “Pulse Energy Adjustment For Changes In Ablation Spot Size” Ser. No. 60/494,274; ABI-11 “Ablative Material Removal With A Preset Removal Rate or Volume or Depth” Ser. No. 60/494,273; ABI-12 “Fiber Amplifier With A Time Between Pulses Of A Fraction Of The Storage Lifetime”; ABI-13 “Man-Portable Optical Ablation System” Ser. No. 60/494,321; ABI-14 “Controlling Temperature Of A Fiber Amplifier By Controlling Pump Diode Current” Ser. No. 60/494,322; ABI-15 “Altering The Emission Of An Ablation Beam for Safety or Control” Ser. No. 60/494,267; ABI-16 “Enabling Or Blocking The Emission Of An Ablation Beam Based On Color Of Target Area” Ser. No. 60/494,172; ABI-17 “Remotely-Controlled Ablation of Surfaces” Ser. No. 60/494,276 and ABI-18 “Ablation Of A Custom Shaped Area” Ser. No. 60/494,180; were filed Aug. 11, 2003. ABI-19 “High-Power-Optical-Amplifier Using A Number Of Spaced, Thin Slabs” Ser. No. 60/497,404 was filed Aug. 22, 2003;

Co-owned ABI-20 “Spiral-Laser On-A-Disc”, Ser. No. 60/502,879; and partially co-owned ABI-21 “Laser Beam Propagation in Air”, Ser. No. 60/502,886 were filed on Sep. 12, 2003. ABI-22 “Active Optical Compressor” Ser. No. 60/503,659 and ABI-23 “Controlling Optically-Pumped Optical Pulse Amplifiers” Ser. No. 60/503,578 were both filed Sep. 17, 2003;

ABI-24 “High Power SuperMode Laser Amplifier” Ser. No. 60/505,968 was filed Sep. 25, 2003, ABI-25 “Semiconductor Manufacturing Using Optical Ablation” Ser. No. 60/508,136 was filed Oct. 2, 2003, ABI-26 “Composite Cutting With Optical Ablation Technique” Ser. No. 60/510,855 was filed Oct. 14, 2003;

ABI-28 “Quasi-Continuous Current in Optical Pulse Amplifier Systems” Ser. No. 60/529,425 and ABI-29 “Optical Pulse Stretching and Compressing” Ser. No. 60/529,443, were both filed Dec. 12, 2003;

ABI-30 “Start-up Timing for Optical Ablation System” Ser. No. 60/539,026; ABI-31 “High-Frequency Ring Oscillator”, Ser. No. 60/539,024; and ABI-32 “Amplifying of High Energy Laser Pulses”, Ser. No. 60/539,025; were filed Jan. 23, 2004; and

ABI-33 “Semiconductor-Type Processing for Solid-State Lasers”, Ser. No. 60/543,086, was filed Feb. 9, 2004; and ABI-34 “Pulse Streaming of Optically-Pumped Amplifiers”, Ser. No. 60/546,065, was filed Feb. 18, 2004. ABI-35 “Pumping of Optically-Pumped Amplifiers”, was filed Feb. 26, 2004.

Although the present invention and its advantages have been described above, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification, but only by the claims.

1. A method of controlling ablation based on analysis of material removed from a surface, comprising:
generating an initial wavelength-swept-with-time optical pulse;
amplifying the initial pulse;
compressing the amplified pulse to a duration of less than 10 picoseconds;
applying the compressed optical pulse to the surface to cause material to be emitted from the surface;
analyzing the material being emitted to at least partially determine composition of the removed material; and
using the analysis of material composition to adjust pulse energy and/or stop ablation.

2. The method of claim 1, wherein the determination uses luminescence or atomic adsorption analysis of material being emitted to determine composition of the removed material.

3. The method of claim 1, wherein the amplifying is done with either an optically-pumped-amplifier or a SOA.

4. The method of claim 1, wherein the pulse has a duration of less than 1 picosecond.

5. The method of claim 1, wherein the material removal is analyzed by both luminescence and atomic adsorption.

6. The method of claim 1, wherein more than one optical amplifiers are used in a train mode.

7. The method of claim 1, wherein the composition of material being sensed is analyzed to determine when the ablation reaches a buried stop-indication layer.

8. The method of claim 1, the optical ablation of material removal is used during semiconductor fabrication or cutting of a composite material.

9. The method of claim 1, the optical ablation of material removal is used during a medical procedure.

10. The method of claim 3, wherein the amplifier is optically-pumped Cr:YAG amplifier.

11. The method of claim 1, wherein pulse repetition rate is controlled based on a set-point that is determined by material composition analysis.

12. The method of claim 1, wherein ablation is stopped based on material composition analysis.

13. The method of claim 1, wherein optically-pumping rate is controlled based on a set-point that is determined by material composition analysis.

14. The method of claim 1, wherein pulse energy density and ablation rate are independently controlled.

15. The method of claim 1, wherein pulse energy density, optically-pumped amplifier operating temperature, and ablation rate are independently controlled.

16. A method of controlling an ablation system, comprising:
applying an optical pulse with a duration of less than 10 picoseconds to a surface, to cause material to be emitted from the surface;
using analysis of material being emitted to determine at least some of the composition of the removed material; and
using the composition determination in the control of the system.

17. The method of claim 16, wherein luminescence is used in the determination.

18. The method of claim 16, wherein atomic adsorption is used in the determination.

19. A method of controlling ablation based on analysis of material removed from a surface, comprising:
time compressing a wavelength-swept-with-time optical pulse;
applying the compressed optical pulse to the surface, to cause material to be emitted from the surface;
analyzing the material being emitted to at least partially determine composition of the removed material; and
using the determination of material composition to control the ablation.
